(19) United States
(12) Patent Application Publication
(10) Pub. No.: US 2022/0120874 A1
(43) Pub. Date: Apr. 21, 2022

(54) Sensor Assembly and Method for a Vehicle for Capturing Distance Information

(71) Applicant: Volkswagen Aktiengesellschaft, Wolfsburg (DE)

(72) Inventors: Thomas Ruchatz, Leiferde (DE); Stefan Wohlenberg, Braunschweig (DE)

(73) Assignee: Volkswagen Aktiengesellschaft, Wolfsburg (DE)

(21) Appl. No.: 17/432,825

(22) PCT Filed: Jan. 15, 2020
(86) PCT No.: PCT/EP2020/050941

§ 371 Date: Sep. 21, 2021

(30) Foreign Application Priority Data
Feb. 21, 2019 (DE) 10 2019 202 327.4

(51) Int. Cl. G01S 7/4863; G01S 17/931; G01S 7/4914

(52) U.S. Cl. CPC G01S 7/4863; G01S 7/4914; G01S 17/931

(57) ABSTRACT

The invention relates to a sensor assembly and a method for a vehicle for detecting distance information, wherein the detection information is detected based on strip-shaped areas and distance histograms formed therefor, more precisely, with reference to intersecting areas of these strip-shaped areas. It is provided that the detected strip-shaped areas of a scene each correspond to strip-shaped areas of a sensor of the sensor assembly, and for a plurality of the corresponding strip-shaped areas, the light received therein is determined simultaneously.

### CROSS-REFERENCE TO RELATED APPLICATIONS

This application claims priority to German Patent Application No. DE 10 2019 202 327.4, filed on Feb. 21, 2019 with the German Patent and Trademark Office. The contents of the aforesaid patent application are incorporated herein for all purposes.

### TECHNICAL FIELD

The invention relates to a sensor assembly and a method for a vehicle, for example for a motor vehicle such as for example a passenger car or a truck for detecting distance information. The detection principle may generally be based on the detection of light (i.e., electromagnetic radiation) within the visible or invisible range.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

In the context of vehicles, it is known to detect scenes within a vehicle, or in the environment of the vehicle, by means of optical sensors. For example it is known to shine light with predetermined properties into the scene and to receive light reflected from the scene by means of a light-sensitive sensor. According to the received light, measuring signals may be generated, and these may be evaluated to obtain distance information or in other words proximity information.

This information may then be used by various driver assistance systems. Lighting systems of a vehicle, in particular LED-based lighting systems, may be used as the light source for generating and radiating light which may then be detected by sensors in a reflected form. Including in the context of the present invention, the lighting system may for example include daytime running lights, high beams, low beams, a turn signal light, fog lights, or the like.

To shorten the evaluation time and reduce requirements on the sensors, strip-shaped areas may be formed for which distance histograms are determined. Based thereupon, distance information may then be determined for intersecting points of the strip-shaped areas.

The teaching of DE 10 2013 002 671 A1 is incorporated herein by way of reference in its entirety.

It was recognized that optimum distance detection is not achievable in the prior art.

### SUMMARY

A need exists to further improve the strip-shaped light detection. The need is addressed by the subject matter of the independent claims. Embodiments of the invention are described in the dependent claims, the following description, and the drawings.

### BRIEF DESCRIPTION OF THE DRAWINGS

FIG. 1 schematically shows a vehicle according to an embodiment and an object in an environment of the vehicle;

FIG. 2 shows steps of a method for determining a distance to an object according to an embodiment;

FIG. 3 shows steps of a method for determining a speed of an object according to an embodiment;

FIG. 4 schematically shows a circuit of an LED light source according to an embodiment that is equipped to emit light for a distance measurement;

FIG. 5 schematically shows the arrangement of components of the LED light source from FIG. 4 in a common semiconductor housing;

FIG. 6 shows steps of a method for determining a distance of an object according to another embodiment;

FIG. 7 shows first detection areas of sensors of a device for determining the position of an object according to an embodiment;

FIG. 8 shows second detection areas of sensors of a device for determining a position of an object;

FIG. 9 shows an overlap of the first and second detection areas of FIGS. 7 and 8 as they are detected by sensors of a device for determining a position of an object according to an embodiment;

FIG. 10 shows the second detection areas of FIG. 8 with an additional blur;

FIG. 11 shows the overlap of the first and second detection areas of FIG. 9 with an additional blur of the second detection areas;

FIG. 12 shows transmitter segments as they are used by a light source of a device according to an embodiment to detect a position of an object;

FIG. 13 shows receiver segments as they are used by sensors of a device according to an embodiment to determine a position of an object;

FIG. 14 shows an overlap of the transmitter segments of FIG. 12 and the receiver segments of FIG. 13;

FIG. 15 shows a near field view of transmitter segments that are generated according to an embodiment by an offset arrangement of transmission diodes;

FIG. 16 shows a far field view of the transmitter segments of FIG. 15;

FIG. 17 shows method steps of another method for determining distance information according to an embodiment;

FIG. 18 shows a scene with an object in an environment of a vehicle;

FIG. 19 shows distance histograms of rows of the scene of FIG. 18;

FIG. 20 shows distance histograms of columns of the scene of FIG. 18;

FIG. 21 shows a vehicle according to an embodiment that simultaneously measures a distance to a preceding vehicle and transmits data;

FIG. 22 shows steps of a method according to an embodiment for determining a distance of an object and for transmitting transmission data;

FIG. 23 shows a schematic section of an example of a sensor assembly that executes a method according to an exemplary embodiment; and

FIG. 24 shows a schematic section of a sensor assembly according to another exemplary embodiment.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In contrast to the solution from DE 10 2013 002 671 A1 that provides sequential measured value detection for the individual strip-shaped areas as results from the measuring time data at the end of paragraph [0067], the teachings herein provide detecting measured values of the strip-shaped areas simultaneously, or respectively in parallel at least in part. For example, all strip-shaped areas, however at least 10% of all the provided strip-shaped areas, may be detected in parallel, or in other words read out.

A measured value may be understood to be a measured value generated at a predetermined point in time, and for example a measured signal value that is obtained for the corresponding strip-shaped area. The measured value, or respectively the measured signal value, may also be a value distribution relative to a specific point in time. The measured value is for example one of the above-described distance histograms, or respectively may be used to form such.

A benefit of the disclosed solution is that the observed scene may be detected at least partially and for example completely all at once. The simultaneously detected light, or respectively the simultaneously generated measured values based thereupon, accordingly form the scene at the same time. This reduces motion blur which may arise during sequential detection and simultaneous relative movement between the sensor and scene. Expressed otherwise, with the solutions proposed herein, motion blur may occur at most during the comparatively short parallel illumination time, or respectively readout time, whereas with the known solutions, movement blur may arise during the cumulative illumination times for all the sequentially evaluated strip-shaped areas.

Another benefit results from the fact that the shone light may be better exploited due to the at least partially parallel measured value detection over a plurality of the strip-shaped areas. In comparison to the previous solution, comparatively short shone light pulses or pulse trains are sufficient, between which comparatively long pauses are also possible. This enables potential savings in terms of hardware and for example in association with utilized lighting sources.

It should be noted that to practically implement the teaching of DE 10 2013 002 671 A1, several detection cycles including all associated illumination cycles may have to be provided in certain circumstances, for example one for first strip-shaped areas (for example in the row direction), and others for second strip-shaped areas (for example in the column direction). With the present solution, one detection and illumination cycle may contrastingly be sufficient since the light from several strip-shaped areas is detected in parallel.

In detail and a first exemplary aspect, an (optical) sensor assembly for a vehicle for detecting distance information is proposed comprising:
an (optical) sensor that is configured to receive (visible or invisible) light which is reflected by a scene in the environment (of the sensor assembly);
a (for example electronic) processing unit that is configured to determine several first distance histograms depending on the received light, wherein a particular first distance histogram of the several first distance histograms is assigned a particular first strip-shaped area of the scene, wherein the first distance histogram includes a strength of reflections in a distance area by objects in the assigned first strip-shaped area; and
that is furthermore configured to determine several second distance histograms depending on the received light, wherein a particular second distance histogram of the several second distance histograms is assigned a particular second strip-shaped area of the scene, wherein the second distance histogram includes a strength of reflections in a distance area by objects in the assigned second strip-shaped area; and
that is furthermore configured to determine distance information for an area of the scene depending on the several first distance histograms and the several second distance histograms, wherein the area of the scene includes an intersecting area of one of the first strip-shaped areas with one of the second strip-shaped areas;

wherein the strip-shaped areas of the scene each correspond with strip-shaped areas of the sensor, and

wherein the sensor assembly (and for example its processing unit) is configured to simultaneously determine the light received therein of a plurality of the corresponding strip-shaped areas (or in other words, to read out, and/or simultaneously determine measured values for the corresponding strip-shaped areas).

It may therefore be provided that an assignment, or respectively correspondence, exists between the areas of a scene, the strip-shaped areas with which the scene is detected, and the strip-shaped areas of a, or respectively on a, sensor. For example, it may be provided that a scene is detected by means of (for example virtual) strip-shaped areas of the aforementioned type, and these strip-shaped areas are formed, or respectively provided by corresponding areas of the sensor, and for example the sensor elements available therein that will be described below. The first and second strip-shaped areas may therefore be as it were virtual, but attributable to a corresponding grouping, or respectively arrangement of sensor elements within the sensor that divide the scene into correspondingly detectable strip-shaped areas. For example, the strip-shaped areas may correspond to rows and columns of a sensor subdivided like a matrix (i.e., the corresponding strip-shaped areas of the sensor may be its rows and columns).

In general, the sensor may enable a scene to be depictable by means of a two-dimensional detection area that is divided into correspondingly strip-shaped areas, or respectively that may be assigned the aforementioned strip-shaped areas with which the scene is to be detected.

The sensor may include several sensor elements that each have at least one photodetector (or photodetector element as well). The sensor elements may be SiPMs (silicone photomultipliers) that for example may be constructed of several smaller photodetectors (such as from so-called SPADs—single photon avalanche diodes). Alternatively, the sensor elements may be formed from so-called PIN diodes.

The photodetectors may be arranged in a matrix, or respectively grid and accordingly may have a row and a column direction that are perpendicular to each other as well as generally speaking the sensor, or respectively a detection area defined thereby.

The determination of received light for the corresponding strip-shaped areas may also be termed reading out or evaluating these areas, wherein the latter for example also includes forming the corresponding distance histograms (or in other words area-wise measured value generation).

All measured values or measuring signals may generally be determined with time resolution. The sensor assembly may also include a memory apparatus in which the measuring signals may be saved (for example time-resolved). The time-resolved signals that are for example received per pixel and/or sensor element may also receive a time-resolved sum signal per row and column, for example at the same time. This may then be converted into a distance-resolved signal, or respectively into a distance histogram using the methods described herein.

The parallelism, or respectively simultaneity of reading out may be achieved in that each strip-shaped area is assigned its own (electrical) line into which all sensor elements feed their signals within this strip-shaped area (or respectively within a corresponding strip-shaped area of the sensor). These may be the row and column lines explained below.

It may be provided for all corresponding strip-shaped areas (of the sensor) to be able to be read out simultaneously, at least however all strip-shaped areas (of the sensor) that correspond to the first or second strip-shaped areas.

According to some embodiments, it may be provided to simultaneously determine the light received therein of at least 50% (and for example at least 25% or at least 10%) of the corresponding strip-shaped areas.

In general, it may furthermore be provided that the corresponding strip-shaped areas of the sensor are (for example virtually) divided into areas in which the light received therein is determined simultaneously, and into areas in which the light received therein is not determined simultaneously. In the last-mentioned areas, a sequential evaluation, or respectively a readout may be performed instead.

In this context, it may furthermore be provided that the areas (at least) partially lie within an edge area of the sensor without simultaneously determining the received light. The edge area of the sensor may for example be understood to be a row and/or column area (or generally an area) that includes up to 10% or up to 5% of the total number and/or the total surface area of the rows, and/or columns (or generally the total number and/or the total surface area of the corresponding strip-shaped areas) of the sensor, and that for example lies to one side of a geometric center of the sensor, and for example also includes a row and/or column forming the outermost edge (or generally a strip-shaped area forming the outermost edge).

A benefit of this version is that the simultaneous and more precise detection of a central area of the sensor may be reserved, and less precise sequential detection may occur in the edge areas in which fewer events relevant to the vehicle will probably be observed.

As already noted, the sensor may include a sensor matrix with sensor elements arranged in rows and columns that are each configured to receive light, wherein the rows with the first strip-shaped areas correspond to the scene, and the columns with the second strip-shaped areas correspond to the scene.

In general, the sensor and for example the sensor elements may each detect a (light) intensity of the received light. The sensor elements may supply pixel values and/or define individual pixels, or respectively picture elements of the sensor matrix. Simultaneously recorded pixel values as well as sequentially recorded pixel values that refer to the same detection process may be considered together and for example used to derive common distance histograms.

The sensor elements in the rows and columns are for example each interconnected (for example by being connected to common electrical (signal) lines, and for example to common row, or respectively column lines), and the distance histograms are for example determined from an overall signal of correspondingly interconnected sensor elements. The corresponding first and second strip-shaped areas of the sensor may be formed by being interconnected.

In some embodiments, at least those sensor elements whose received light is determined simultaneously each include a current mirror arrangement that is connected to a row line and to a column line to which other current mirror arrangements of other sensor elements are also connected. This makes it possible to combine the measuring signals obtained per sensor element by row, or respectively by column and then also form the corresponding distance histograms therefrom. Furthermore, this version is for example suitable if the sensor elements are SiPMs. In general, this is a reliable and positive option for forming, or respectively detecting the strip-shaped areas. The current mirror arrangement may be formed conventionally by two e.g. parallel-connected (semiconductor) transistors and will be explained below in an example with reference to the FIGS.

Another version provides that the sensor elements each include at least one PIN detector that is connected to two resistors in order to feed the current falling there into lines (for example into a signal line and a row line) that are assigned to the strip-shaped areas. The PIN detector may be connected to a transimpedance amplifier, and its output voltage may be applied to the corresponding resistors.

Moreover, it may be provided that at least those sensor elements whose received light is simultaneously determined (i.e., that are simultaneously read out) include at least two photodetector elements that each receive light (i.e., each may be read out, or respectively each provide a measuring signal), and wherein one of the photodetector elements is connected to a row line, and the other to a column line. The photodetector elements may be designed as aforementioned SPADS, for example if the sensor element is a SiPM. For example, but not restricted to the latter case, a sensor element may include up to 16 or up to 32 photodetector elements.

By means of this version, additional hardware elements such as for example the aforementioned current mirror may be spared, and a reliable ability of the strip-shaped areas to be read out in parallel may nonetheless be achieved.

Moreover, it may be provided that more than two photodetector elements per sensor element are provided (such as 16 or 32, see above) and these are combined into two for example equal size groups, wherein the photodetector elements of the one group are connected to a row line, and the photodetector elements of the one group are connected to a column line, and wherein at least two photodetector elements of the one group include at least one photodetector element of the other group between themselves. Expressed otherwise, the photodetector elements of the two groups may be arranged nested in each other and/or alternatingly (for example in the row and in the column direction). In general, the photodetector elements of the two groups may thus be arranged like a chessboard pattern. By means of a corresponding group-shaped arrangement, a high resolution may be ensured despite subdividing individual sensor elements into separate detection areas (i.e., into separate photodetector elements).

A second exemplary aspect relates to a method for a vehicle for detecting distance information, comprising:
reception of light with a sensor that is reflected by a scene in the environment;
determination of several first distance histograms depending on the received light, wherein a particular first distance histogram of the several first distance histograms is assigned a particular first strip-shaped area of the scene, wherein the first distance histogram includes a strength of reflections in a distance area by objects in the assigned first strip-shaped area;
determination of several second distance histograms depending on the received light, wherein a particular second distance histogram of the several second distance histograms is assigned a particular second strip-shaped area of the scene, wherein the second distance histogram includes a strength of reflections in a distance area by objects in the assigned second strip-shaped area;
determination of distance information for an area of the scene depending on the several first distance histograms and the several second distance histograms, wherein the area of the scene includes an intersecting area of one of the first strip-shaped areas with one of the second strip-shaped areas;

wherein the strip-shaped areas of the scene each correspond with strip-shaped areas of the sensor, and

wherein, for a plurality of the corresponding strip-shaped areas, the light received therein is determined simultaneously (or in other words, a plurality of the corresponding strip-shaped areas of the sensor are read out simultaneously).

All of the explanations above and below of the features of the sensor assembly may also apply to the identical features of the methods. For example, the method may include any additional step in any additional feature for providing all or some of the functions, operating states or effects described herein that are associated with the sensor assembly. For example, the method may be executed with a sensor assembly according to any of the above and below embodiments.

According to some embodiments of the sensor assembly and the method, the scene is illuminated with an light emitting diode (LED) light source of the vehicle. The LED light source may include a lighting apparatus of the vehicle for illuminating an environment or an interior the vehicle. The lighting apparatus may for example include daytime running lights, high beams, low beams, a turn signal light, fog lights, etc. The LED light source may be actuated using a modulation method, and the distance histogram may be determined depending on the modulation signal and a receive signal of the sensor matrix. The modulation method may for example include a frequency-modulated continuous wave method in which a frequency with which the LED light source is modulated is modified over a certain time from a starting frequency to an end frequency. The modulation frequency is for example continuously modified from the starting frequency to the end frequency. Moreover, a random frequency modulation method may be used as the modulation method in which a frequency with which the LED light source is modulated is modified randomly or pseudo-randomly. Moreover, the LED light source may be actuated using a single frequency modulation method in which a frequency for modulating the LED light source is constant. Finally, the LED light source may be actuated using a pulse modulation method. Depending on the employed modulation method, various evaluation methods may be used for determining the distance histograms. For example, correlation methods may be used that correlate a signal which was used to modulate the LED light source with a receive signal of the sensor matrix. In another evaluation method, the modulation signal may be mixed with the receive signal, and the distance may be determined depending on the mixing frequency. The distance histograms represent in principle distance-resolved echograms that are generated by an object or several objects in the strip-shaped detection area. These distance-resolved echograms may be processed using a method similar to that of a CAT scan into a spatially resolved image, wherein each location of the image is assigned a corresponding distance. All of the aforementioned methods are also applicable for simultaneously reading out at least individual strip-shaped areas.

Since the distance histograms each include an entire row or an entire column of the scene, fewer sensors with a coarse resolution (row or column sensors) are necessary or, if a matrix sensor is used, only a few row and column measurements are needed instead of measurements for each picture element. Accordingly, a high resolution with few sensors, or respectively few measurements is possible.

According to the present aspect, a device for detecting distance information for a vehicle may moreover be provided. The device includes a light source that is equipped for illuminating a scene in an environment or within the vehicle. The light source is for example a lighting apparatus of the vehicle. Moreover, the lighting apparatus for example includes LEDs for generating the light since LEDs may be modulated at a sufficiently high frequency to provide light that may be used for the determination of distance histograms described below. The device furthermore comprises a sensor assembly of the aforementioned type for receiving light that originates from the light source and was reflected by the scene. Finally, the device includes a processing unit that actuates the light source and determines several first distance histograms and several second distance histograms of the aforementioned type depending on the received light.

The present invention will be described further in detail below with reference to the drawings.

Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

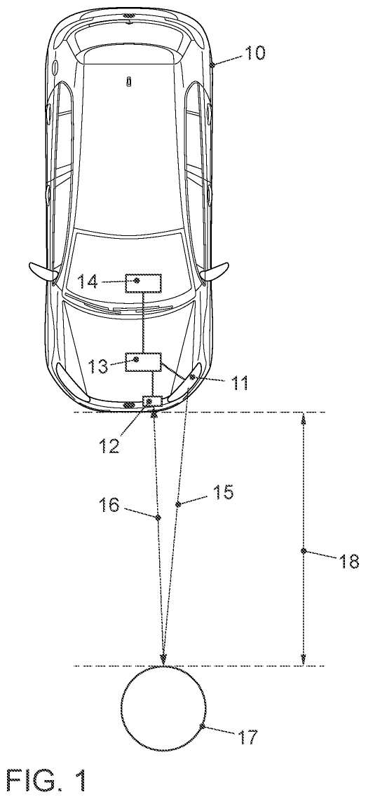

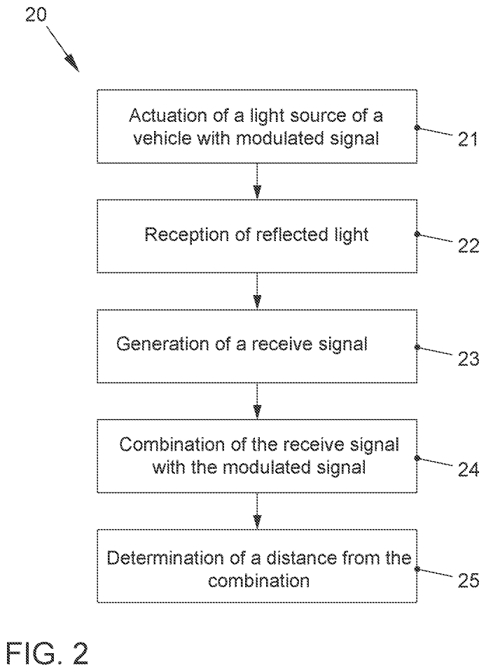

FIG. 1 shows a vehicle 10 with a device for determining distance information. The device includes a light source 11 that is equipped to illuminate an object 17 in an environment of the vehicle 10. The light source 11 may for example include daytime running lights, low beams, a turn signal light, tail lights, high beams, fog lights, or backup lights of the vehicle 10. The light source may furthermore include one or more LEDs that generate light for illuminating the environment of the vehicle 10, or a signaling light, for example the light of a turn signal light or brake light. The light source 11 may moreover also include an illumination apparatus for illuminating an interior of the vehicle 10 such as for example a dashboard illumination or a passenger compartment illumination. The device for determining the distance information furthermore includes an optical sensor 12 for receiving light reflected by the object 17 and a processing unit 13 that is coupled to the light source 11 and the sensor 12. If the object 17 is for example at a distance in the area in front of the vehicle 10 in the arrangement shown in FIG. 1, light 15 that was emitted by the light source 11 is reflected by the object 17 and received as reflected light 16 by the sensor 12. The mode of operation of the device for determining distance information will be described below with reference to FIG. 2.

FIG. 2 shows a method 20 for the vehicle 10 for determining the distance 18 between the vehicle 10 and the object 17. In step 21, the light source 11 of the vehicle 10 is actuated using a modulated signal. The modulated signal is generated by the processing unit 13. The light 15 that was emitted by the light source 11 is reflected by the object 17 and received as reflected light 16 by the sensor 12 (step 22). In step 23, a receive signal is generated depending on the received reflected light 16. The receive signal may for example include an analog or digital electrical signal. In step 24, the receive signal is combined with the modulated signal in the processing unit 13. For example, the modulated signal and the receive signal may be correlated or mixed as will be described in detail below. The distance 18 to the object 17 is determined in step 25 from a combination signal, for example a correlation signal or a mixed signal. The distance to the object 17 determined in this way may for example be provided to a driver assistance system 14 of the vehicle 10. The driver assistance system 14 may for example include an adaptive cruise control system, a brake assist system, a park assist system, or a collision warning system. The object 17 may also be located in the interior of the vehicle 10 and be illuminated by a corresponding lighting apparatus of the vehicle in the interior, and the reflected light from the object may be received by a corresponding sensor. This allows distances to objects in the interior of the vehicle to be determined, for example to recognize gestures of an operating system, or for example to detect a current position of a head of a passenger in an accident in order to trigger corresponding safety mechanisms such as for example airbags.

So that the above-described method may be used in a vehicle for different driver assistance systems, it is necessary to use different transmitting and receiving methods for the different applications. These methods may for example be chosen depending on the required distance or application. To accomplish this, for example an operating state of the vehicle 10 may be determined, and a corresponding transmission and reception method may be selected depending on the operating state of the vehicle, i.e., a corresponding modulation method for generating the modulated signal and a corresponding evaluation method (such as mixing or correlating) is selected depending on the operating state. The modulation method may for example include a frequency modulated continuous wave method, a random frequency modulation method, a single frequency modulation method, or a pulse modulation method. These methods will be described below in detail. The operating state of the vehicle may for example include a speed of the vehicle, an activation state of a light source of the vehicle that indicates whether the light source is or is not turned on to illuminate an environment of the vehicle or to output an optical signal, a driving direction of the vehicle, previously determined position information or distance information of an object in the environment of the vehicle, weather conditions in the environment of the vehicle, or a type of assistance device of the vehicle that is provided the distance information.

In the frequency modulated continuous wave method, also termed FMCW or the chirp method, a modulation frequency is modified over a certain time from a starting frequency to an end frequency. For example, the modulation frequency is continuously modified from the starting frequency to the end frequency. As will be shown later, the method may be used not just for distance measurement, but also for a speed measurement of the object 17. The generation of modulation signals in which a modulation frequency is continuously modified over a certain time from a starting frequency to an end frequency is known in the prior art, and the method may therefore be easily implemented, for example by blanking a synthetically generated waveform. With the method, the distance 18 to the object 17 may be measured continuously, whereby the method is particularly suitable for light sources 11 that are continuously turned on. A frequency ramp results by continuously modifying the modulation frequency and hence the transmission frequency of the light source 11 from a starting frequency to an end frequency. By mixing the transmit signal with the receive signal that is received by the sensor 12, both the distance 18 as well as the speed of the object 17 may be measured directly. When using light emitting diodes (LEDs) as a light source 11 that have typical response times of 5-10 ns, modulation frequencies may be used up to for example a maximum of 100 MHz. The FMCW modulation may accordingly for example use the transmission frequency of 10 MHz to 100 MHz continuously or over a time period of for example 0.5-400 μs. The distance may optionally be measured when using the frequency modulated continuous wave method (FMCW) by means of frequency mixing or a correlation method.

When the frequency modulated continuous wave method is used, the transmit and the receive signal may be compared using a frequency mixer. An object at a certain distance generates a mixed frequency that is proportional to the distance. The local resolution of several objects is a function of the resolution of the frequency measurement and therefore the measuring time. Such a frequency measuring method may for example be realized as an analog circuit in an integrated circuit. If for example a distance between 0 m and 40 m is to be measured, the light needs about 3.3 ns/m×40 m×2=264 ns for this distance there and back along the arrows 15 and 16 in FIG. 1. This yields a useful signal length for the FMCW signal of approximately 500 ns. A modulation down to 10 MHz for this method is therefore too low so that for example a frequency deviation between 50 and 100 MHz should be used that is linearly modified over 500 ns. At a distance 18 of for example 25 m between the vehicle 10 and the object 17, the receive signal is delayed by 165 ns in comparison to the transmit signal. As described above, the transmit signal has a frequency deviation of 50 MHz/500 ns=100 kHz/ns due to the modulation. Given a signal delay of the receive signal of 165 ns, the receive signal has a frequency that is lower by 16.5 MHz than the transmit signal. By mixing the transmit signal with the receive signal, a frequency of 16.5 MHz is obtained with the example distance of 25 m. Expressed generally, a frequency of 0.66 MHz per meter distance results from mixing.

In measuring distance using the frequency modulated continuous wave method, the transmit signal and the receive signal may also be correlated with each other to determine the distance to the object 17 on the basis of a correlation signal generated in this manner. To accomplish this, the modulated signal that was transmitted is correlated at a delay with the receive signal. A correlation maximum to the shift time results that is proportional to the distance 18 of the object 17. Since basically distorted signals are evaluated, the level of the correlation maximum is a measure of the signal strength so that different objects 17 may be distinguished. The resolution in the distance may for example be determined by the sampling frequency of the receive signal. To generate the correlation signal, several correlation coefficients may be generated. In so doing, each correlation coefficient of the several correlation coefficients are assigned a particular shift time. Each correlation coefficient is formed by correlating the modulated signal delayed by the particular assigned shift time with the receive signal. The distance to the object is determined depending on the several correlation coefficients, for example by determining an absolute or local maximum and the assigned shift times. In doing so, it is beneficial to use a high signal significance in the time domain by the continuously modulated FMCW signal that contains many frequencies that differ from each other. To achieve a high sampling rate of the receive signal, a one bit conversion may for example be beneficial. To generate the binary receive signal, the receive signal may be generated with a first signal value if a level of the received light falls below a certain intensity, and a receive signal is generated with a second signal value when the level of the received light reaches or exceeds the certain intensity. To accomplish this, for example an amplitude-limiting amplifier may be used that generates a receive signal with distinct levels depending on the received light, for example a binary sequence of zeros and ones. Since it is the time that is significant, scarcely any information is lost by this binary conversion since the significance in the amplitude may be unreliable given the amplitude modulation from the object 17 to be expected. With the receive signal reduced to binary signals, a corresponding correlator may be fabricated comparatively easily and may be suitable for processing long sequences. This improves the correlation result. If the receive signal is digital or binary, it is beneficial for the reference sample of the modulated transmit signal to also be digital. This may be achieved for example in that a synthesized digital signal is used to modulate the light source. This may for example be generated with consistent quality and only depending on a transmission cycle.

If the receive cycle is the same as the transmission cycle, arising errors, for example from temperature drifts, may be compensated. By using the correlation method, long signal sequences may be used. The useful frequency deviation is accordingly not restricted to the runtime of the signal for the distance to be measured. As described above, the method may be realized in a purely digital matter and may therefore be economically constructed. For example, a modulated signal with a length of 50 μs-500 μs may be transmitted, and the frequency may be increased during this time from 10 MHz to 100 MHz. Such a modulated signal may for example be generated using a shift register in which a synthetically generated signal is stored. A clock frequency with which the transmit signal may be synchronously clocked out and the receive signal may be clocked in may for example be 1 GHz, and is therefore realizable with comparatively little effort. The measuring time of 50 μs-500 μs is fast enough for most applications of driver assistance systems so that multiplex methods in multichannel sensors are also possible. Moreover, several measurements may be performed and averaged to further improve the signal quality.

The modulated signal with which the light source 11 is actuated may moreover be generated using a random frequency modulation method. In doing so, a transmit frequency from a frequency band is randomly varied over a specific time. This method is also termed random frequency modulation (RFM). To determine the distance from the object 17, the previously described correlation method may be used in a comparable manner. The random frequency modulation method offers very strong interference resistance, for example against scattered light and other measuring methods. Moreover, several measuring channels may be measured simultaneously since corresponding crosstalk from other measuring channels are suppressed by the correlation evaluation. The modulation frequencies and the length of the time of the transmit signal may be selected to be comparable with those of the frequency-modulated continuous wave method. The random frequency modulation method may accordingly be used for example when several light sources simultaneously illuminate a scene or a space and all are to be measured simultaneously. For example, measurements may be performed simultaneously with all of the headlights of the vehicle 10 using the random frequency modulation method. In doing so, each light source is given its own significant signature that may then be distinguished by using the correlation method. Moreover, data that are encoded in the modulation signal may be simultaneously transmitted to other vehicles or receivers at the roadside. For continuous distance measurement, continuous actuation of the light source 11 is necessary, so that this method is particularly suitable for light sources which are continuously on, such as for example daytime running lights or a headlight during night travel. The above-described frequency-modulated continuous wave method and the above-described random frequency modulation method may also be used in combination. For example due to the improved signal quality, the frequency-modulated continuous wave method may be used initially. If interference sources are detected such as light sources from other vehicles, there may be a switch to the random frequency modulation method. Likewise there may be at least a temporary switch to the random frequency modulation method when data transmission is necessary. The light source 11 and the sensor 12 may equally be used for the frequency-modulated continuous wave method as well as for the random frequency modulation method.

In the method for determining the distance to the object 17, furthermore a single frequency modulation method for generating the modulated signal may be used to actuate the light source 11. The single frequency modulation method uses a constant modulation frequency and is therefore very easy to realize. Contrastingly, it may however be interfered with comparatively easily by fog, spray, dust or foreign light sources, and may therefore be used for example in applications where such interference cannot arise, for example due to the installation site, or if a temporary failure may be tolerated, such as for example in a distance measurement in the interior, or with park assists with which measuring too closely does not have any negative consequences and the necessary distances are small due to the low speed of the vehicle, or the development of spray is unproblematic. For continuous distance measurement, a permanently active light source is also necessary in the single frequency method, so the single frequency method may for example be used in conjunction with for example daytime running lights or low beams of the vehicle. A determination of the distance, i.e., an evaluation of the single frequency modulation method, may for example be reduced to a phase measurement in which a phase difference is determined between the modulated signal and the receive signal. For example, the phase may be digitally measured via an and-link by a comparison of the receive signal with the modulated signal. Suitable typical modulation frequencies are for example within a range of 5-20 MHz. Within this range, clarity of the phase evaluation based on the single frequency modulation may be ensured.

Finally, a pulse modulation method may be used to generate the modulated signal for actuating the light source 11. The pulse modulation method may for example also be used to measure when the light source 11 is turned off. The short light pulses of the pulse modulation method may be configured so that they are invisible or scarcely visible to the viewer. If a light source is turned on, the pulse modulation method may also be used by configuring the light source for the pulse duration or, expressed otherwise, by generating “negative” light pulses. The pulse modulation method is therefore particularly attractive when measuring is to be with a low measuring frequency of for example 10 to 100 Hz, and the light for measuring should not be discernible. Light sources such as for example low beams, a turn signal light, tail lights, brake lights or backup lights that are not turned on at the time of measurement may be turned on with brief pulses having a length of for example 10 to 100 ns that are not noticed by a human observer due to the low average output. When light sources are turned on, the light may for example be turned off for a short time period of for example 10 to 100 ns, whereby a negative light pulse arises that may also be detected by the sensor 12. The distance 18 to the object 17 may for example be determined using the above-described correlation method when using the pulse modulation method. For example, a pulse modulation may be used that consists of a pulse sequence which has a high time significance over nonuniform pulse spacings. The receive signal generated depending on the received light may in turn be correlated with the modulated signal, or alternatively, a mathematical description of the pulse may serve as a correlation pattern for the pulse modulation. The receive signal may be sampled over the measuring distance. By using an oversampling method, several such echograms may be recorded and added up as a distance histogram. Echo pulses may be recognized using pulse evaluation, and for example a precise distance 18 may be determined for example by centroid determination. The method is suitable both for positive pulses as well as for negative pulses.

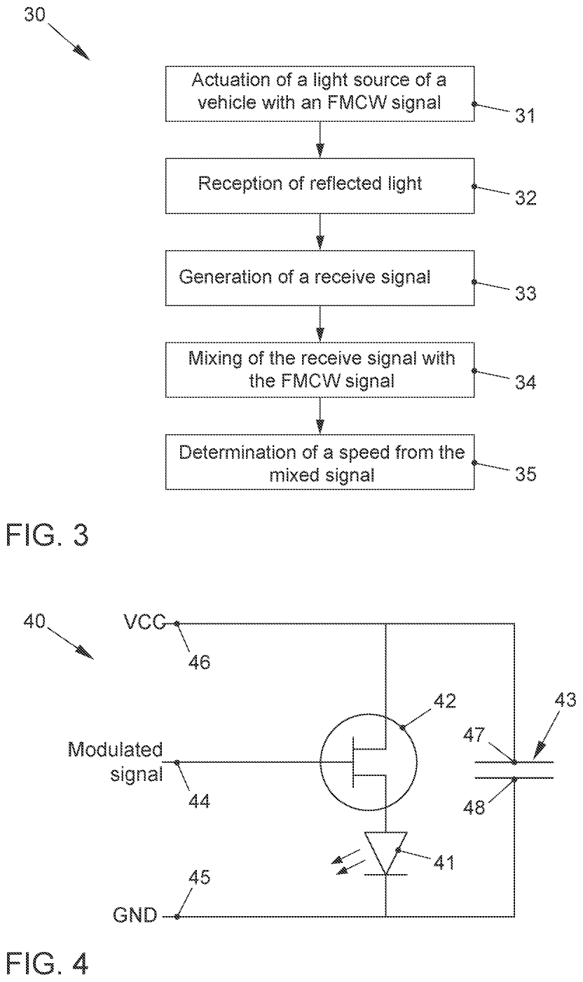

As already mentioned above in conjunction with the frequency-modulated continuous wave method, a speed of the object 17 may also be determined in addition to the distance 18 to the object 17. This will be described in detail below with reference to FIG. 3. FIG. 3 shows a method 30 for determining a speed of the object 17. In step 31, the light source 11 of the vehicle 10 is actuated using a frequency-modulated signal. In step 32, the reflected light 16 is received that was emitted by the light source 11 and reflected by the object 17 in the environment of the vehicle 11. In step 33, a receive signal is generated depending on the received light 16. In step 34, a differential frequency is determined between a frequency of the frequency-modulated signal with which the light source 11 was actuated and a frequency of the receive signal by mixing the two signals. Speed information on the object 17 is determined in step 35 from the mixed signal, i.e., depending on the differential frequency. The frequency-modulated signal may for example be generated according to the above-described frequency-modulated continuous wave method in which the modulation frequency of the frequency-modulated signal is modified over a certain time from a starting frequency to an end frequency. As described above, distance information to the object 17 may also be determined depending on the receive signal and the frequency of the frequency-modulated signal, for example by mixing the signals or correlating the signals. The frequency of the frequency-modulated signal for example lies within a range of 10 to 200 MHz.

An example of the method will be described below in detail with reference to a modulation with the assistance of a frequency-modulated continuous wave method (FMCW). In FMCW modulation, a continuous frequency deviation of for example 10 MHz to 100 MHz is modulated over 40 μs. With a distance of 200 m between the vehicle 10 and the object 17, a shift of 1.32 μs or 2.97 MHz results. With a relative speed of v, another mixing sequence according to the Doppler formula results:

$$f = ( \frac{c}{c + v} ) \cdot {f}_{0}$$

where f is the modulation frequency, f₀ is the frequency of the receive signal, and c is the speed of light. The following table shows the Doppler frequency shift for various speeds of the object.

| | | | Modulation frequency | | | | | | | |
|---|---|---|---|---|---|---|---|---|---|---|
| Doppler frequency | | | 20 MHz | 40 MHz | 60 MHz | | 80 MHz | | 100 MHz | |
| Speed | 20 | km/h | 0.37 Hz | 0.74 Hz | 1.11 | Hz | 1.48 | Hz | 1.85 | Hz |
| | 40 | km/h | 0.74 Hz | 1.48 Hz | 2.22 | Hz | 2.96 | Hz | 3.70 | Hz |
| | 60 | km/h | 1.11 Hz | 2.22 Hz | 3.33 | Hz | 4.44 | Hz | 5.56 | Hz |
| | 80 | km/h | 1.48 Hz | 2.96 Hz | 4.44 | Hz | 5.93 | Hz | 7.41 | Hz |
| | 100 | km/h | 1.85 Hz | 3.70 Hz | 5.56 | Hz | 7.41 | Hz | 9.26 | Hz |
| | 120 | km/h | 2.22 Hz | 4.44 Hz | 6.67 | Hz | 8.89 | Hz | 11.11 | Hz |
| | 140 | km/h | 2.59 Hz | 5.19 Hz | 7.78 | Hz | 10.37 | Hz | 12.96 | Hz |
| | 160 | km/h | 2.96 Hz | 5.93 Hz | 8.89 | Hz | 11.85 | Hz | 14.81 | Hz |
| | 180 | km/h | 3.33 Hz | 6.67 Hz | 10.00 | Hz | 13.33 | Hz | 16.67 | Hz |
| | 200 | km/h | 3.70 Hz | 7.41 Hz | 11.11 | Hz | 14.81 | Hz | 18.52 | Hz |
| | 220 | km/h | 4.07 Hz | 8.15 Hz | 12.22 | Hz | 16.30 | Hz | 20.37 | Hz |
| | 240 | km/h | 4.44 Hz | 8.89 Hz | 13.33 | Hz | 17.78 | Hz | 22.22 | Hz |
| | 260 | km/h | 4.81 Hz | 9.63 Hz | 14.44 | Hz | 19.26 | Hz | 24.07 | Hz |

The table shows that the Doppler frequency depends on the modulation frequency. A higher modulation frequency also leads to a higher Doppler frequency. The FMCW modulation may therefore be modified for example so that, for example over 20 μs, the frequency of 10 MHz is modulated to 100 MHz, and the frequency of 100 MHz is held for another 20 μs. The Doppler frequency may then for example be measured at 100 MHz. The Doppler frequency may for example be determined directly by mixing the transmit frequency within the receive frequency. For practical reasons, the Doppler frequency may however be alternatively determined by mixing the receive signal with another signal that has a frequency deviating by a predetermined value from the frequency of frequency-modulated transmit signal. For example, the receive signal may be compared or mixed with a signal that has a frequency less by 100 kHz than the frequency-modulated transmit signal. Consequently frequencies between 100,000 and 100,024 Hz are obtained for the Doppler frequency in the example shown in the table for speeds between 0 and 260 km/h. These clearly higher frequencies may be measured more easily and may arise within the measuring period for example of 20 μs.

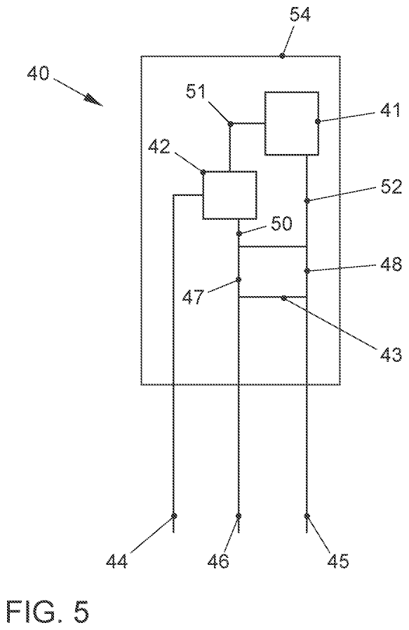

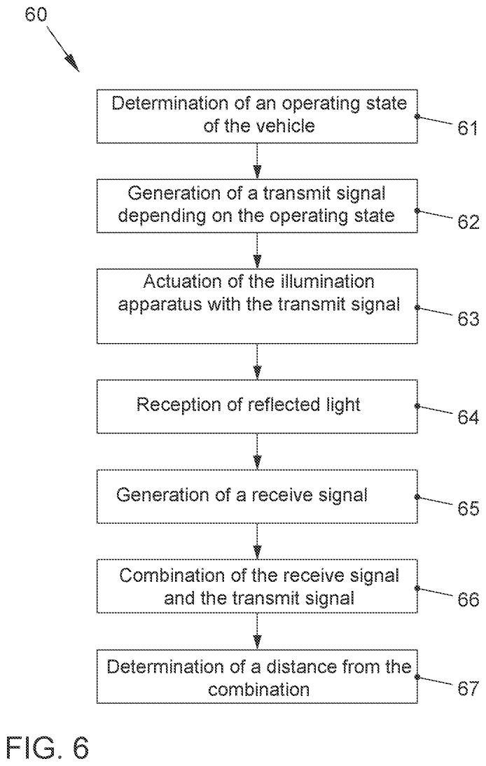

As described above, the light source 11 of the vehicle 10 should for example be modulated within a frequency range of 10 MHz to 100 MHz. To accomplish this, for example LED light sources are suitable that use semiconductor LEDs to generate the light 15. For example, LEDs that generate ultraviolet or blue light have such a large modulation bandwidth. To change the color to white light or differently colored light components such as for example red or green light, these LEDs may additionally have phosphorus coatings that convert ultraviolet light or blue light into differently colored light. The high-frequency light for distance measurement or speed measurement is for example the blue light of the LEDs. The currents through the LEDs lie within a range of a few amperes to achieve corresponding light ranges. To achieve efficient modulation, a corresponding actuation of the LED must be correspondingly designed. FIG. 4 shows an LED light source 40 that is also termed a modulation circuit and that has a corresponding design. The LED light source 40 includes an LED 41, a switch element 42 and an energy storage element 43. The LED 41 can, as described above, for example include an LED that generates blue light, or at least a blue light component. The switch element 42 may for example include a transistor, for example a field effect transistor. The energy storage element may for example include a capacitor. The switch element 42 is actuated by a modulated signal 44. An energy supply includes a ground connection (GND) 45 and a power supply connection (VCC) 46. If the switch element 42 switches through due to an actuation of the modulated signal 44, a current flows from the supply voltage connection 46 through the LED 41 to the ground connection 45, and moreover, an additional current of a charge stored in the energy storage element 43 flows from a first connection 47 through the switch element 42 and the LED 41 to a second connection 48 of the energy storage element 43. Given the high switching frequencies, a design with extremely short lines for example between the elements 41, 42 and 43 is desirable so that the inductance of the lines is minimized, and therefore loss, susceptibility to interference and for example radiated interference are minimized. When the switch element 42 is in a disabled state, the energy storage element 43 is charged by the supply voltage 46 and the ground connection 45. When the switch element 42 is in a conductive state, the energy storage element provides a very large current through the LED 41 for a short period. Therefore, for example the connections between the energy storage element 43, the switch element 42 and the LED 41 should be minimized. If the lines in the circuit of the LED 41, switch 42 and energy storage 43 are too long, they constitute an inductor that counteracts any change in current. Consequently, a very high voltage is needed to be able to produce a modulation that constitutes a fast current change. In this context, just a few millimeters of line length may have a significant influence. The energy that is stored in the lines during the modulation is partially absorbed in the lines and converted into heat, and partially emitted as interference radiation. To for example generate 10 W of light with the LED 41, a current of approximately 10 amperes through the LED 41 is needed. If the light pulse is for example supposed to be 50 ns long, approximately 200 V are needed in a wired design in which the LED 41, the switch element 42 and the capacitor 43 are arranged as separate elements on a printed circuit. Accordingly, an energy requirement of 200 V×10 A×50 ns=0.1 mJ is needed. With an SMD design, for example 60 V and 10 A are necessary, i.e., an energy requirement of 30 μJ. With an optimized design that in the following will be presented in conjunction with FIG. 5, only 8 V and 10 A are necessary, i.e., an energy requirement of 4 μJ. In every case, about 40 W are absorbed by the LED 41. The efficiency in an optimized design is therefore 50%, in an SMD design, it is about 6%, and in a wired design on a printed circuit, the efficiency is only 2%.

FIG. 5 shows the optimized design of the LED light source 40. The LED light source 40 includes the LED 41, the switch element 42 and the energy storage element 43. The switch element 42 is coupled in a series circuit to the LED 41. The energy storage element 43 is coupled in parallel to the series circuit of the LED 41 and switch element 42. If the switch element 42 is switched through, a current path is switched through the LED 41 that runs from a first connection 47 of the energy storage element 43 via a first line section 50 to the switch element 42, and runs from there via a second line section 51 to the LED 41. The current path runs via a third line section 52 to the second connection 48 of the energy storage element 43. As shown in FIG. 5, the elements 41, 42 and 43 are arranged in a common housing 54. Expressed otherwise, the semiconductor elements 41 and 42 as well as the capacitor 43 are accommodated in the common housing 54 without their own housing. The lengths of the connections 50 to 52 may therefore be designed correspondingly short. For example, the overall current path that connects the energy storage element 43, the LED 41 and the switch element 42 may have a length less than 12 mm. For example the length of the current path is shorter than 9 mm. Each of the connections 50, and 52 may for example be 1 to 3 mm. Together with the connections 44 to 46, the connections 50 to 52 may form a so-called lead frame that on the one hand provides the external connections 44 to 46 of the LED light source 40 and on the other hand the connections 50 to 52 to couple the elements 41 to 43. Given the short lengths of the connections 50 to 52, a high efficiency of the LED light source 40 may be achieved. Several LED light sources may be realized in the housing 54 in that correspondingly several LEDs 41, switch elements 42 and energy storages 43 are arranged on a common lead frame in the common housing 54. The LED 41 may generate light with a wavelength of less than 760 nm, for example less than 500 nm, i.e., for example blue light. Moreover, a phosphorus coating may be provided in the housing 54 that converts ultraviolet light or blue light that is generated by the LED 41 into differently colored light. The LED light source 40 or several of the LED light sources 40 may be used in a lighting apparatus 11 of the vehicle 10 in order for example to illuminate an environment of the vehicle 10, or to generate a light signal such as for example a flashing light or a brake light.

In the previously described methods and devices, available lighting apparatuses of the vehicle such as for example headlights of low beams, fog lights, turn signal lights, brake lights or backup lights are used to generate a modulated light signal that is reflected by an object in the environment of the vehicle and is received by a sensor in the vehicle. A distance or a speed of the object may be determined from the receive signal of the sensor and the awareness of the modulated signal with which the lighting apparatus of the vehicle was actuated. Since the primary function of the lighting apparatus is to illuminate an environment of the vehicle or output a light signal such as for example a flashing signal or a brake signal, a method 60 will be described in the following that simultaneously ensures a determination of distance information.

To accomplish this, first an operating state of the vehicle is detected in step 61. The operating state of the vehicle may for example be a target state for the lighting apparatus of the vehicle that indicates whether the lighting apparatus should be turned on or off. Detecting the operating state may furthermore include determining an environmental brightness in an environment or within the vehicle, or determining a distance measuring area for which the distance information is to be determined. Depending on the operating state determined in this manner, a modulated transmit signal is generated in step 62. For example, a first modulated transmit signal may be generated when the target state of the lighting apparatus indicates that the lighting apparatus should be turned on. Moreover, a second modulated transmit signal may be generated that is inverted to the first modulated transmit signal when the target state indicates that the lighting apparatus should be turned off. Accordingly for example when the lighting apparatus is turned off, a modulated transmit signal may be generated that includes short light pulses whose energy is insufficient to be seen by an observer. Conversely if the lighting apparatus is to be turned on, a modulated transmit signal may be generated that turns off the lighting apparatus for short pulses which are so short that they are not noticed by an observer, and the lighting apparatus therefore appears to be continuously turned on. In step 63, the lighting apparatus 11 of the vehicle 10 is actuated by the generated transmit signal. In step 64, reflected light 16 is received which was emitted as light 15 from the lighting apparatus 11 and reflected by the object 17. Depending on the received light 16, a receive signal is generated in step 65. In step 66, the receive signal is combined with the transmit signal, and in step 67, the distance of the object 17 is determined from the combination.

The amount of light that cannot be seen by an observer depends inter alia on an overall brightness of the environment of the vehicle and a contrast in the transmission domain. In the daytime, significantly larger amounts of light may be emitted by the lighting apparatus that are not noticed by an observer than at night. Typically, a signal-to-noise ratio is significantly worse in the daytime from the interfering light of the sun so that higher transmission outputs are needed in the daytime than at night. In the daytime, for example outputs of up to 2 mJ may be emitted that are not noticed by an observer. In the method, an average output of the modulated signal may therefore be adjusted depending on the operating state, for example an environmental brightness. Moreover, the transmission energy may be adjusted depending on a distance measuring area for which the distance measuring information is to be determined. This depends for example on the need of an application which uses the distance information. A driver assistance system for a distance regulation or a collision avoidance system may require a larger distance measuring area than a parking system.

The modulated transmit signal may for example include a pulse modulated signal. The pulse-modulated signal may have a pulse duration within a range of 1 to 500 ns, for example 10 to 100 ns. A frequency with which the pulses of the pulse-modulated signal are repeated may be within a range of 1 to 1000 Hz, for example 10 to 100 Hz.

The lighting apparatus of the vehicle may for example include the above-described LED light source, or several LEDs. With white LEDs, the primary blue light component may be used as a modulation carrier. This is modulated at a high frequency with the modulated transmit signal and remains in the spectrum of the white LED. The phosphorus of the LED cannot follow the fast modulations since it is generally sluggish. This yields a white, continuously shining light to human perception, whereas its blue component has the desired modulation.

Depending on the operating state of the vehicle and the modulated transmit signal, another lighting apparatus of the vehicle may be actuated. The vehicle 10 is for example driving on a country road, and a driver assistance system such as for example an adaptive cruise control is turned on. The headlights of the vehicle are turned off. Consequently, a modulated transmit signal is generated that includes brief light pulses. Distance information to an object in front of the vehicle may therefore be provided for the adaptive cruise control system. It is therefore unnecessary to turn on a driving light of the vehicle, i.e., the entire energy for all LED illuminants of the headlights of the vehicle does not have to be provided, which for example may be beneficial for an electric vehicle. For example the adaptive cruise control system requires a large measuring range. If, as described above, the headlights are turned off during the day, the high beams may for example be used with high energy to transmit measuring pulses that have a long range. If contrastingly the vehicle is driving in the dark, the high beams are modulated by briefly reducing the brightness to enable the large measuring range. If an oncoming vehicle is approaching in the dark, it is however no longer possible to operate the high beams so as not to blind the driver of the oncoming vehicle. In this case, LEDs of the low beams may be modulated by briefly reducing the brightness in order to determine distance information. At the same time, LEDs of the high beams may be modulated with short pulses to determine distance information without blinding the oncoming traffic. Expressed otherwise, some LEDs are briefly turned on (in this case, LEDs of the turned off high beams), and other LEDs are briefly turned off (in this case, LEDs of the low beams). This may enable a large measuring range without the LEDs for the high beams blinding or disturbing the oncoming vehicle.

In the above-described methods and devices, a distance of the object 17 or a speed of the object 17 was determined using a lighting apparatus 11 that is already available in the vehicle such as for example low beams, daytime running lights, or high beams of the vehicle 10. In the following, it will be described how, by using the above-described methods, position information, i.e., additionally direction information, of the object 17 may also be determined with respect to the vehicle 10.

In some embodiments, the sensor 12 of the vehicle 10 includes at least two first sensors for receiving light that was generated by a light source 11 of the vehicle, and that was reflected by a scene that includes the object 17 in the environment of the vehicle. Each of the at least two first sensors is assigned a particular first detection area of the scene. The first detection areas are arranged in a row in a first direction. FIG. shows 15 first detection areas that are assigned 15 first sensors. The 15 first detection areas are arranged in a horizontal direction. Two of the 15 first detection areas are identified with reference signs 71 and 72. The sensor 12 moreover includes at least two second sensors for receiving light reflected by the scene, wherein each of the at least two second sensors is assigned a particular second detection area of the scene. The second detection areas are arranged in a row in a second direction. The second direction differs from the first direction. FIG. 8 shows two second detection areas 81 and 82 that are arranged in a row in a vertical direction. Moreover, additional detection areas are shown in FIG. 8 that are also arranged in pairs in a row in the vertical direction, for example the two third detection areas 83 and 84. The processing unit 13 is designed to determine a position of the object 17 in the environment of the vehicle 10 depending on signals of the first and second sensors. One of the first detection areas, for example the area 71, at least partially overlaps one of the second detection areas, for example the area 81. The one of the first detection areas, i.e., the area 71, may also partially overlap another of the second detection areas, for example the area 82 as shown in FIG. 9. The third detection areas 83, 84 that are monitored by corresponding third sensors may be arranged such that one of the first detection areas, such as the detection area 71, partially overlaps one of the second detection areas, for example the area 81, another of the second detection areas, for example the area 82, one of the third detection areas, for example the area 83, and another of the third detection areas, for example the area 84.

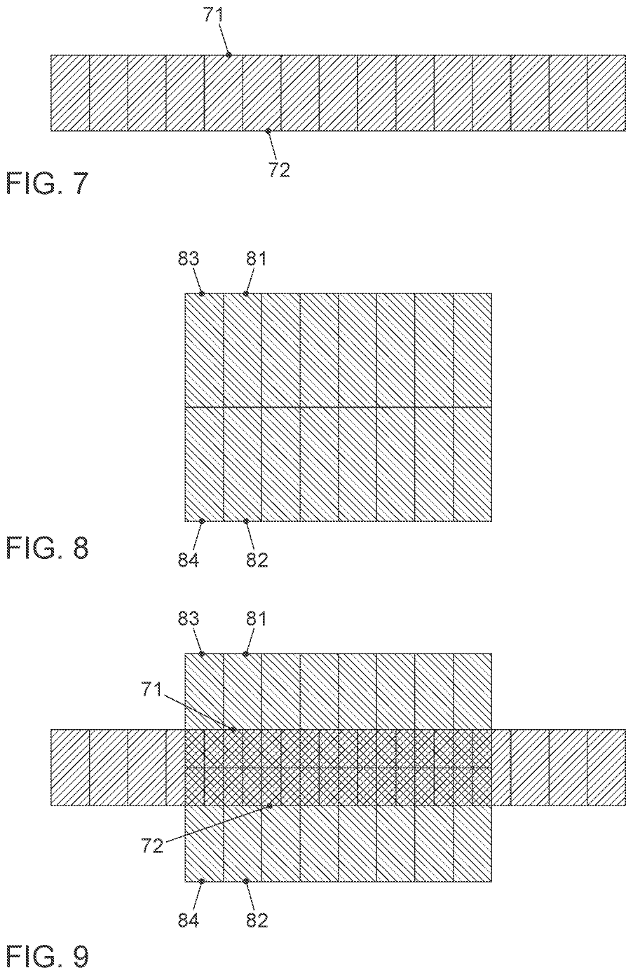

The determination of the position of the object 17 with the assistance of the overlapped detection areas as described above will be described below in detail. In comparison, it is noted at this juncture that, with nonoverlapping detection areas having for example five detection areas, only five different position areas for the object 17 may be distinguished. Given the overlap of the detection areas as shown in FIG. 9, eight different position areas for the object 17 may however be distinguished with the detection areas 71 and 81-84. If only the sensor that is assigned to one of the detection areas 81-84 detects the object 17, the object 17 is located in an area that is assigned to the corresponding sensor and that does not cover the area that is assigned to the sensor 71. Accordingly four different areas for the object 17 may already be distinguished. If the object 17 is detected in one of the areas 81-84 and additionally in the area 71, the object 17 must be located in one of the four overlapping areas that result from the overlapping of the area 81 with the area 71, the area 82 with the area 71, the area 83 with the area 71, or the area 84 with the area 71. This allows four additional position areas for the object 17 to be distinguished. If the sensors are arranged so that the detection areas shown in FIGS. 7 and 8 may be monitored separately, the overlap shown in FIG. 9 may allow a total of 56 different areas to be realized in which the object 17 may be directly detected with the necessary 15 first sensors for the areas of FIG. 7 and the 16 sensors for the areas of FIG. 8.

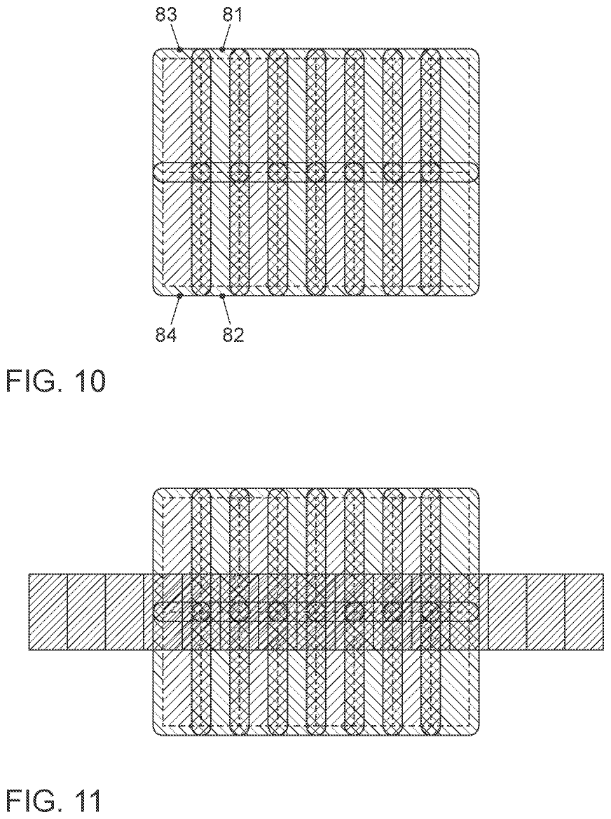

The second detection areas may for their part also overlap in the vertical direction, and may also overlap in the horizontal direction with additional detection areas such as the third overlapping areas 83, 84. This may for example be achieved by a so-called “blur” of the assigned sensors. FIG. 10 shows the above-described overlap of the second, third, and additional detection areas. In combination with the first detection areas of FIG. 7, a plurality of different areas may accordingly be provided for determining the position of the object 17 as shown in FIG. 11. By overlapping the first detection areas with each other, the resolution in determining the position of the object 17 may be further increased, which however is not shown in FIG. 11 for reasons of clarity. FIGS. 9 and 11 furthermore also show that for example in the center, i.e., in the area in which the horizontally arranged and vertically arranged detection areas overlap, a particularly high resolution for determining the position of the object 17 may be achieved. This may be beneficially used for many driver assist systems of a vehicle since for example in the straight orientation of the vehicle, a high resolution is beneficial, whereas a low resolution in the edge area may generally be tolerated.

The detection areas in FIG. 7-11 are perpendicular to the measuring direction, i.e., perpendicular to the arrow 16 in FIG. 1.

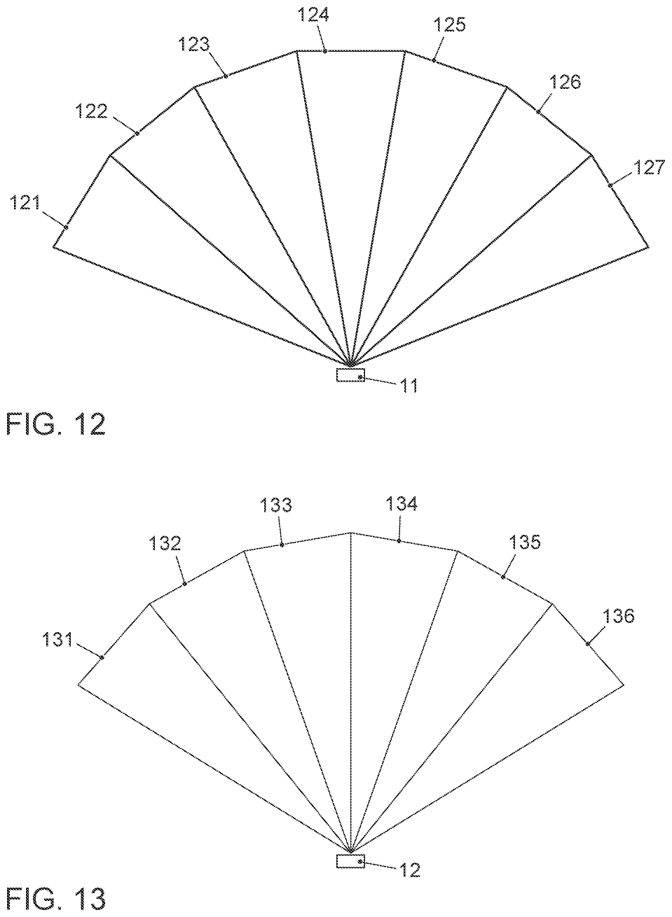

In conjunction with FIG. 12-14, an additional option is shown of determining position information of the object 17 relative to the vehicle 10.

The lighting apparatus 11 of the vehicle 10 has at least one first light source and one second light source. The first and second light source may be actuated independent of each other. The first light source is designed to illuminate a first lighting area of a scene in an environment or within the vehicle 10. The second light source is designed to illuminate a second lighting area of the scene. The first lighting area is different from the second lighting area. A plurality of lighting areas 121-127 is shown in FIG. 12. For example, the first lighting area may be the area 121, and the second lighting area may be the area 122. The sensor 12 includes at least one first sensor and one second sensor for receiving light reflected by the scene. In this case, the first sensor is assigned a first detection area of the scene, and the second sensor is assigned a second detection area of the scene. The first detection area is different from the second detection area. Six detection areas 131-136 are shown in FIG. 13. The first detection area may for example be the area 131, and the second detection area may for example be the area 132. The processing unit 13 actuates the first and second light source and if applicable other light sources for generating the lighting areas 123-127, and determines a position of the object 17 in the environment of the vehicle 10 depending on signals from the first and second sensors and if applicable other sensors that are assigned to the detection areas 133-136, and depending on the actuation of the light sources. The areas 121-127 and 131-136 lie for example in the plane of the arrows 15 and 16 of FIG. 1.

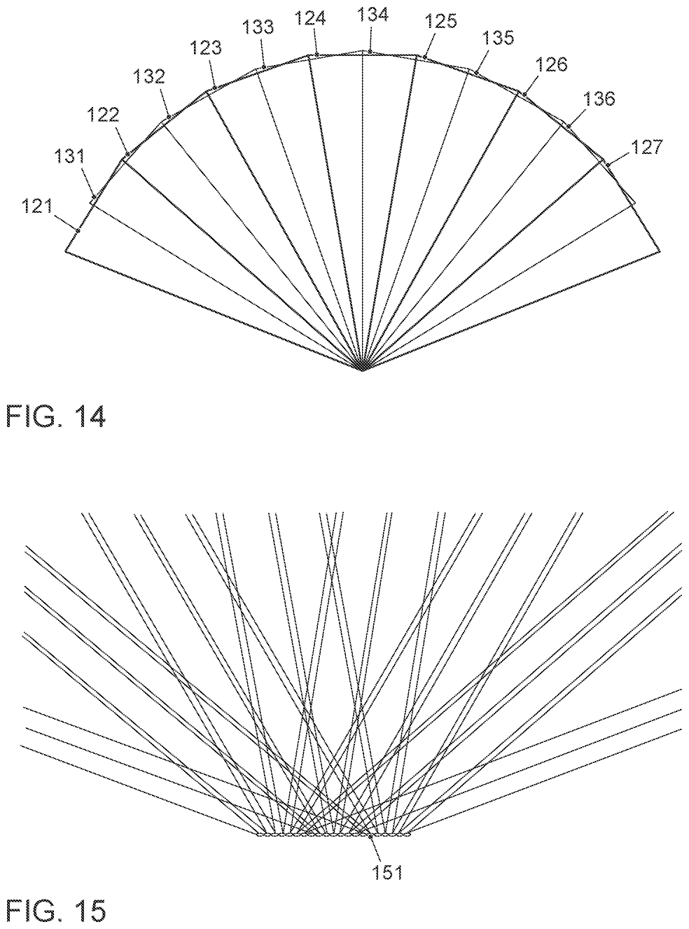

The detection areas may for example be arranged oriented toward the lighting areas, i.e., the detection area 131 corresponds substantially to the lighting area 121, the detection area 132 corresponds substantially to the lighting area 122, etc. Each of the detection areas may have a predetermined angular range, for example 10 or, as shown in FIGS. 12 and 13, 20. The segments formed in this manner may be sequentially sampled in a so-called time division multiplexing method. The entire angular range that is covered by the segments may be sampled over a very short time since, with the above-described distance measuring methods, for example with the frequency-modulated continuous wave method or random frequency modulation method, distance measurements may be performed within a segment within a very short time, for example within 50 μs. If for example an angular range of 120 is to be sampled in 10 segments, the entire angular range may be sampled in 600 μs with a measuring time of 50 μs per segment. Even with a longer measuring time of 500 μs, the entire angular range of 120 may be sampled in 6 ms. Typical applications of driver assist systems require measuring times within a range of 30 ms-50 ms for sufficiently fast sampling to be possible. The resolution of the sampling may be improved by not equipping every angular segment with a corresponding transmitter and receiver, but by using segments that each overlap by one-half. FIG. 14 shows such an overlap of the lighting areas 121-127 with the detection areas 131-136. Both the lighting areas as well as the detection areas each include an angular range of 20. Given the offset overlap of the lighting areas 121-127 with the detection areas 131-136, twelve 10 segments result that may be sampled with seven light sources and six sensors. The segments may be arranged next to each other since a time division multiplexing method is used, and crosstalk from one segment to an adjacent segment is therefore irrelevant. Only one transmitter and receiver pair is operated at any one time so that a segment in which a signal occurs may be clearly ascertained. Expressed otherwise, the first detection area 131 covers a portion of the first lighting area 121 and a portion of the second lighting area 122. The second detection area 132 includes another portion of the second lighting area 122. In this case, the second detection area 132 is separate from the first lighting area 121.

From the arrangement of lighting areas and detection areas described above in conjunction with FIG. 12-14, information may additionally be obtained for estimating visibility when detection areas that are not assigned to a lighting area are simultaneously also evaluated. For example, the light source is operated for the lighting area 121 and the sensor is operated for the detection area 131 for a distance measurement. There is a measuring segment in the overlapping area between the lighting area 121 and the measuring area 131. At the same time or also in a time division multiplexing method, a sensor is queried that is assigned to the detection area 136. If this sensor as well reports a distance signal due to the light emitted for the lighting area 121, this may only arise from secondary scattered light. If, as here, signals arise when the lighting areas and detection areas are quite distant, there is for example very thick fog. If the segments are closer together when for example the detection area 133 supplies a distance signal, measurable secondary scatter occurs even given lower particle densities. By evaluating areas of different distances, the fog may be evaluated with highly accurate gradations. This allows current visibility to be estimated.

To illuminate the environment of the vehicle 10 in a segmented manner, several light sources are needed as described above. To accomplish this, for example a plurality of LEDs of for example low beams or for example daytime running lights that have a linear structure may be used. To achieve a uniform appearance for example with linear daytime running lights, LEDs arranged spaced apart for example in the daytime running lights may be interconnected into groups and may illuminate a particular lighting area. LEDs lying therebetween may illuminate other lighting areas. Expressed otherwise, the first light source that is used to generate the lighting area 121 may for example include at least one first LED and one second LED. A second light source that illuminates the lighting area 122 may also include at least one LED or a plurality of LEDs. The first and the second LED of the first light source and the LED of the second light source are arranged in a row, wherein the LED of the second light source is arranged between the first and second LED of the first light source. Since the brightness of the LEDs may vary in the distance measurement, this offset arrangement may allow these differences in brightness to be imperceptible to an observer. Alternatively, an effect that is more interesting in terms of design may also be thereby created if the differences in brightness are visible to an observer.

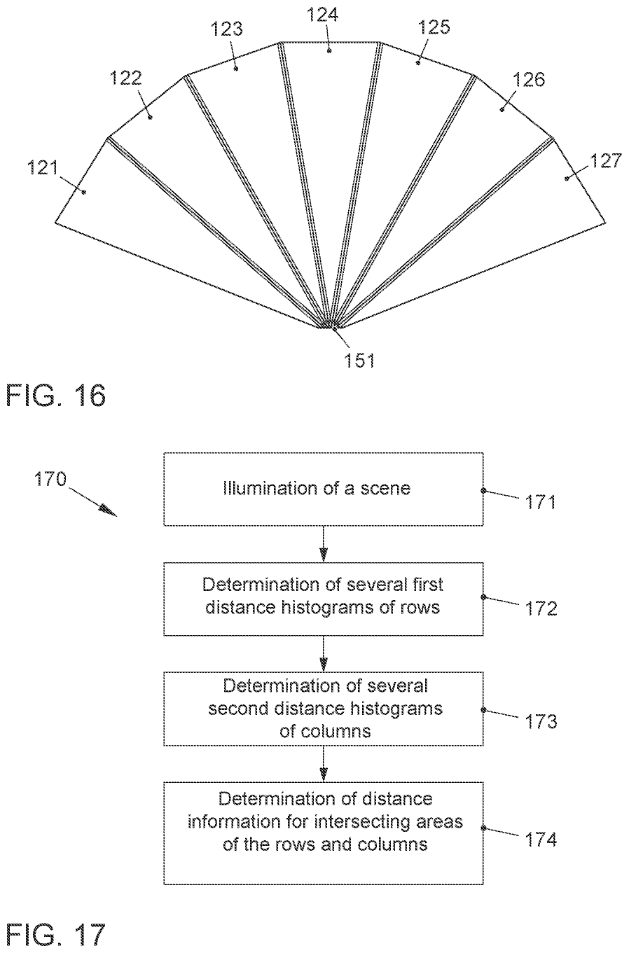

FIG. 15 shows a near field of lighting areas arising from an offset arrangement of LEDs. One light strip 151 includes 21 LEDs. The light strip 151 may for example be a light strip of daytime running lights and have a length of for example 42 cm. With the light strip 151, seven lighting areas or segments are illuminated with an angle of 20° in each case. Each segment is generated by three LEDs at a distance of 14 cm. FIG. 15 shows the segments that may be illuminated by the individual LEDs. The far field of the segments generated by the LEDs of the light strip 151 is shown in FIG. 16. The lighting areas 121-127 spanning approximately 20 are clearly discernible here.

Different assistance systems of a vehicle may require image information of the environment of the vehicle that provide a high resolution of a depiction of a scene in front of the vehicle from the perspective of the vehicle, wherein each area or picture element of the image information is assigned a corresponding distance value to an object in this area. This image information may be necessary in order for example to be able to detect obstacles above or below a certain area, such as for example obstacles located on the roadway such as barriers that may not be run over. FIG. 17 shows a method 170 for determining such distance information. In step 171, the scene is illuminated in the environment of the vehicle. The method 170 may be used not just outside of the vehicle, but also within the vehicle in order for example to recognize gestures by a driver. The light reflected by the scene is received by the sensor 12 of the vehicle 10. In step 172, a plurality of first distance histograms is determined depending on the received light. A particular first distance histogram of the plurality of first distance histograms is assigned a particular first strip-shaped area of the scene. The first distance histogram includes a strength of reflections in a distance area from objects in the assigned first strip-shaped area. In step 173, a plurality of second distance histograms is determined depending on the received light. A particular second distance histogram of the plurality of second distance histograms is assigned a particular second strip-shaped area of the scene. The second distance histogram includes a strength of reflections in a distance area from objects in the assigned second strip-shaped area. In step 174, a distance is determined for an area of the scene depending on the plurality of first distance histograms and the plurality of second distance histograms. The area of the scene includes an intersecting area of one of the first strip-shaped areas with one of the second strip-shaped areas. The first strip-shaped areas are for example parallel to each other along their longitudinal direction, and the second strip-shaped areas are for example parallel to each other along their longitudinal direction. The longitudinal direction of the first strip-shaped areas is for example perpendicular to the longitudinal direction of the second strip-shaped areas. The first strip-shaped areas may include rows from the scene in front of the vehicle or within the vehicle, and the second strip-shaped areas may include columns from the scene. To determine the plurality of first distance histograms and the plurality of second distance histograms, the sensor 12 may include a receiver matrix in which rows and columns may optionally be interconnected so that a receive signal arises either from the sum of all elements in a column, or from the sum of all elements of a row. Then all rows and columns may be measured individually. The distance measurements may for example be performed with one of the above-described methods in that the light source of the vehicle is correspondingly modulated, and the receive signal is correlated or mixed from one of the rows or columns with the transmit signal for the lighting apparatus 11. The receiver matrix may for example have 300 rows and 700 columns, i.e., a total of 1000 rows and columns. With a measuring time per row or column of for example 50 μs, these 1000 measurements may be performed in 50 ms, wherein according to the following embodiments, at least partially and for example completely simultaneous measurement of all rows and columns is provided in the present case.

Per row, or respectively column, a distance-resolved echogram, a so-called distance histogram, is now available. This may be processed using a method similar to that of a CT scan into a pixel-resolved image. To reduce the processing effort, a certain area of interest may be selected using the same method. For this area, the corresponding receive elements of the receiver matrix are interconnected, and only this area is observed and evaluated.

The switch between different areas to be evaluated may be done dynamically and may therefore be adapted to different driving situations.

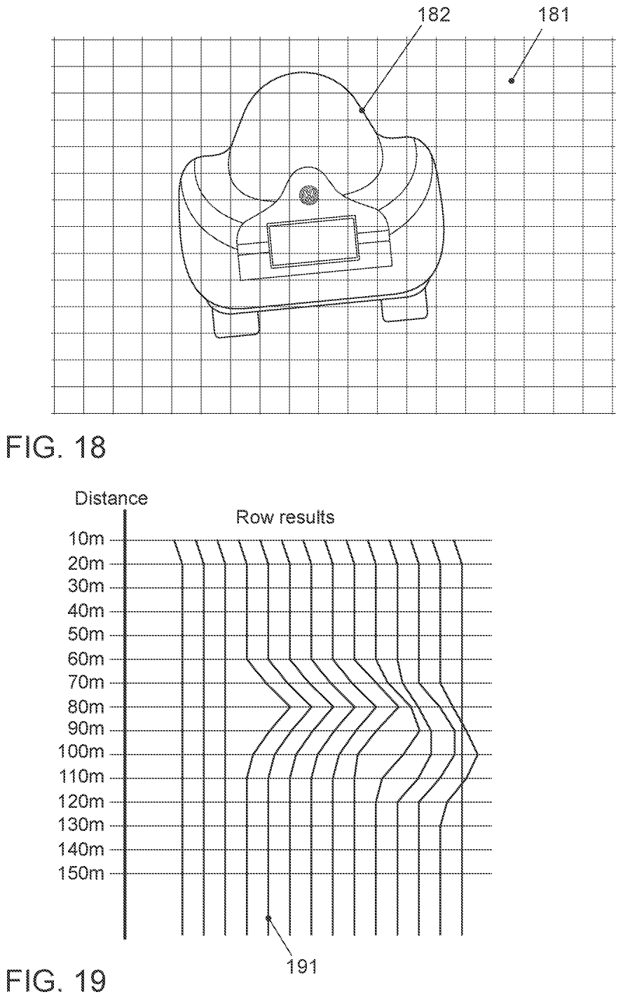

The above-described method will be described below with reference to FIGS. 18 to 20 in an example. FIG. 18 shows a scene in an environment of the vehicle. A vehicle 182 is located on a roadway 181. The scene is divided like a matrix into a plurality of areas. In the example shown in FIG. 18, the scene is divided into 14 rows and 19 columns so that an overall number of 266 areas results. This low number of rows and columns was selected for reasons of clarity in FIGS. 18 to 20. Practical implementations may have for example at least 100 rows and at least 200 columns, for example 300 rows and 700 columns. The sensor 12 accordingly includes for example a sensor matrix with a corresponding row and column resolution. The mination apparatus 11 of the vehicle 10 illuminates the scene shown in FIG. 18 for example with an LED light source, and an evaluation is carried out with one of the above-described modulation methods, for example the frequency-modulated continuous wave method, the random frequency modulation method, the single frequency modulation method or the pulse modulation method. By interconnecting the receiver matrix in rows or columns, distance-resolved echograms are generated for the rows and columns.

FIG. 19 shows corresponding distance-resolved echograms for the 14 rows of the scene in FIG. 18. The echogram for the fifth row from below the scene in FIG. 18 will be described in detail below in an example. The echogram for this fifth row is identified with reference sign 191 in FIG. 19. As may be seen from FIG. 19, the echogram has an elevated signal level in the area of 60 to 110 m. Conversely in the area of 10 to 60 m and in the area of 110 to 150 m, there is substantially no signal level. This means that at least one object is in the area from 60 to 110 m in the fifth column. However, several objects may be in this area. It is not apparent from the echogram in FIG. 19 where the object is located in the horizontal direction, i.e., the column area in which the object is located.

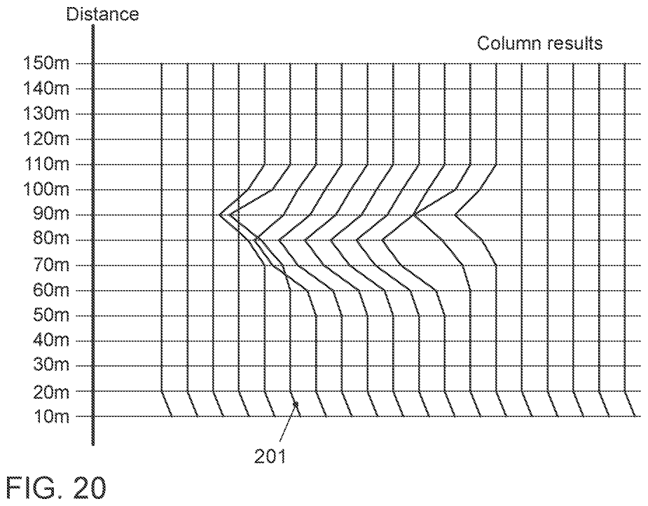

FIG. 20 shows corresponding echograms for the 19 columns of the scene in FIG. 18. For example reference is made in this context to the column 6 from the left in FIG. 18 that is identified with the reference sign 201 in FIG. 20. The echogram 201 of the sixth column indicates that one object or several objects are located in the area from a 60 to 110 m distance. The echogram of the columns also does not contain any information on the distribution of the objects within the column.

From the totality of the echograms, corresponding distance information to objects in the scene may be determined for each of the 266 individual areas of the scene in FIG. 18. Area-specific information may for example be obtained with the assistance of a two-dimensional Fourier transformation from the distance-resolved echograms of the rows and columns.

The distance-resolved echograms in FIGS. 19 and 20 are dimensionless and may for example indicate a relative quantity that indicates the percent of the row, or respectively column-shaped surface area that a particular distance has to the vehicle.

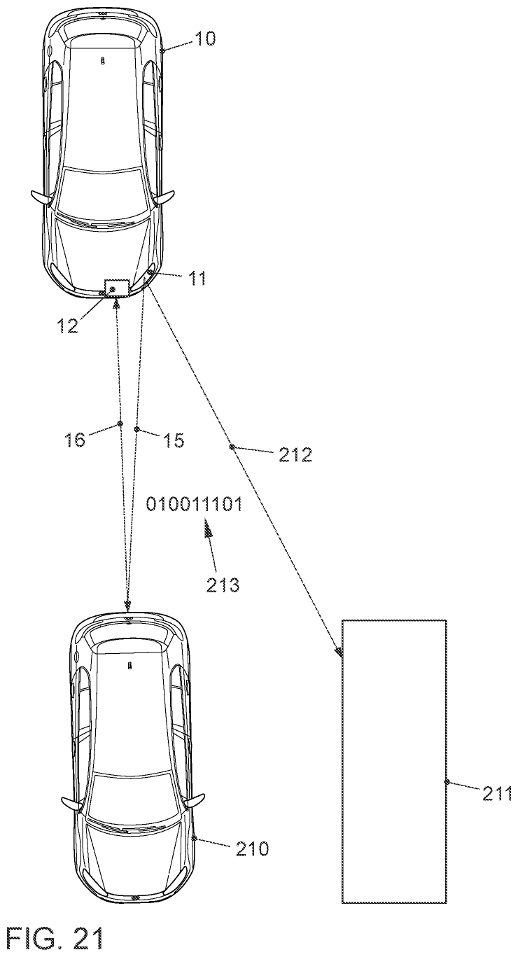

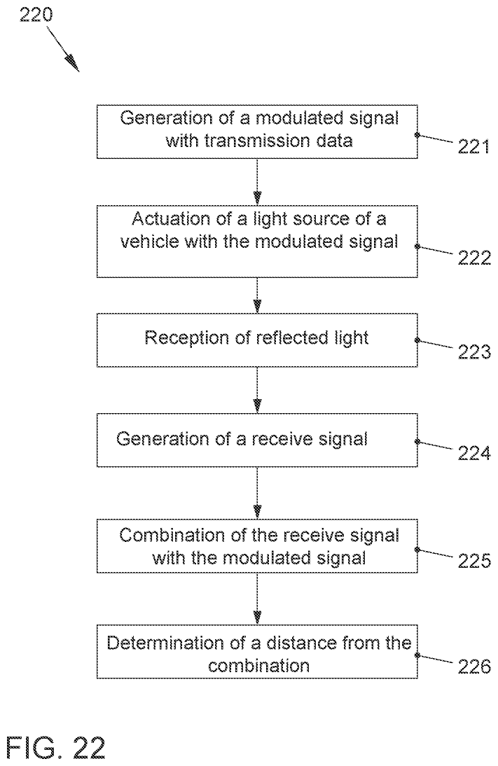

Both in the pulse modulation as well as in the random frequency modulation method (RFM), it is possible to encode information in the transmitted signal 15 that may be decoded by a receiver. This information may for example be used for communication between vehicles, so-called car-to-car communication, or for communication between the vehicle 10 and an infrastructure object, for example a stoplight or a traffic management system. FIG. 22 shows a method 220 with which digital information may be simultaneously transmitted with a distance measurement. FIG. 21 shows the vehicle 10 as well as another vehicle 210 and an infrastructure object 211. With the method 220 described in FIG. 22, a distance between the vehicles 10 and 210 may be simultaneously measured, and information, for example digital information, may be transmitted to the vehicle 210 or the infrastructure object 211.

In step 221, a modulated signal is generated depending on transmit data that are to be sent by the vehicle 10. In step 222, the light source 11 of the vehicle 10 is actuated using the modulated signal. In step 223, light 16 which was emitted as light 15 from the light source 11 and reflected by the vehicle 210 or another object in the environment of the vehicle 10 is received. In step 224, a receive signal is generated depending on the received light. The receive signal may for example include an analog electrical signal or a digital electrical signal. In step 225, the receive signal is combined with the modulated signal, for example with the assistance of the previously described correlation method, and in step 226, the distance between the vehicle 10 and the vehicle 210 is determined from a combination signal from this combination. The modulation method for generating the modulated signal may for example include a random frequency modulation method or a pulse modulation method. In the frequency modulation method, a modulation frequency is modified depending on the transmit data. In the pulse modulation method, a pulse distance or a pulse length is modified depending on the transmit data. The modulated signal may additionally be generated depending on random data.

The data that are to be transmitted from the vehicle 10 are accordingly transmitted in the modulation of the transmit signal. For example as shown in FIG. 21, a bit sequence 213 may be transmitted with the assistance of the modulated transmit signal from the vehicle 10, as well as to the preceding vehicle 210, as well as to the infrastructure object 211 as shown by the light propagation arrows 15 and 212. Receivers in the vehicle 210, or respectively in the infrastructure object 211 may receive the modulated transmit signal, demodulate it, and accordingly recover and further process the transmit data 213. The encoding of the transmit data 213 into the modulated transmit signal will be described below in detail in an example of a pulse modulation method and a random frequency modulation method (RFM).

In the pulse modulation method, light pulses are sent with a pulse repetition rate. This is typically long in comparison with the pulse length of the light pulses. Since it may be problematic for distance measurement when the pulse repetition rate is constant, the distance between the pulses may be varied within a certain range in order to avoid for example beating states. In order to transmit data, this variation may for example divide the distance between the pulses into a static component and into a systematic component. For example, pulses may be used with a length of 50 ns and a pulse repetition rate of 25 kHz, i.e., 40 μs. To measure a distance within a range of for example up to 250 m, a pulse interval of 250 m×6.6 ns/m×2=3.3 μs may not be undershot. Accordingly, it is possible to vary the pulse interval between 3.3 μs and 76 μs. In a system with a transit time distance measurement and a base timing of 25 ns, there are 2,936 possible variations. Of these, for example, 512 may be used to transmit 9 bits. Of these, for example, 6 bits may include the transmission data to be transmitted, and the remaining 3 bits may be varied statistically. Accordingly, the distance between the pulses fluctuates by 12.8 μs from 33.6 to 46.6 μs. Accordingly, 6 bits of transmission data may be transmitted every 40 μs, whereby a net data rate of 150 Kbit/sec is achieved.

For example, in random frequency modulation (RFM), frequencies from 10 MHz to 100 MHz may be varied within 40 μs. In a random frequency modulation method without data transmission, several frequencies are randomly selected statistically from this frequency band, which are then modulated sequentially and therefore result in a frequency train which is significant for the measurement. To transmit the transmission data, the frequency selection is no longer performed randomly but rather includes at least one systematic component. For example, from the band of 10 to 100 MHz, frequencies may be synthesized in frequency steps of 10 kHz. 9,000 different frequencies are therefore possible. Of these, for example, 512 may in turn be used as significant frequencies so that there is a frequency spacing of about 175 kHz for each piece of information. A typical frequency modulation receiver may easily distinguish frequencies of 50 kHz so that the transmitted information may be easily decoded if a frequency spacing of 50 kHz or more is maintained. For the random variation to reduce interference, 125 kHz, or respectively ±62.5 kHz still remain.

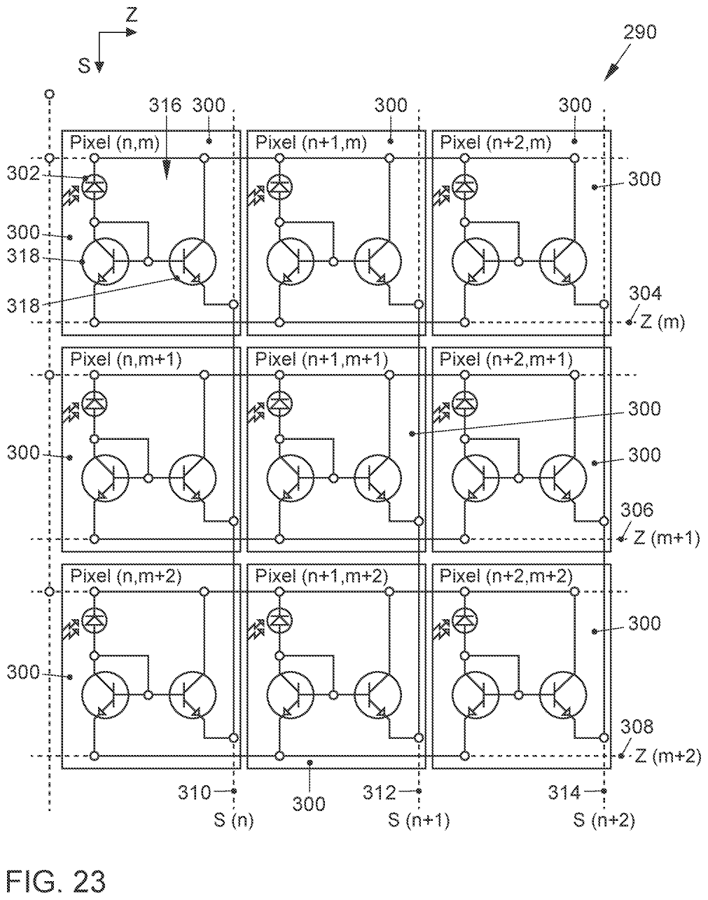

FIG. 23 shows a schematic section of an example of a sensor assembly that executes a method according to an exemplary embodiment. A sensor 290 may be seen that includes a plurality of individual sensor elements 300 which supply measuring signals in the form of an intensity value of received light.

The sensor elements 300 are arranged like a matrix. There is therefore one row and column direction indicated per coordinate system, wherein the rows in FIG. 23 are identified with Z, and the columns with S. For example, a section of three rows and three columns is shown, wherein a significantly higher number may also be provided (see the above examples). A position of the pixels, or respectively sensor elements 300 may be indicated using row and column coordinates, as for example shown in FIG. 23.

Each row Z and each column S forms a strip-shaped area of the type shown herein so that distance histograms are correspondingly formed by row and column. Furthermore, each sensor element 300 supplies a measuring signal that may be read out both in the row as well as in the column direction in the manner described below, for example to form the distance histograms formed by row and column.

The sensor elements 300 are built in the same way. The components of the sensor elements 300 explained below are however not provided with a separate reference sign for each sensor element 300.

Each sensor element 300 includes a photodetector element 302 in the form of a SiPM 302. The SiPM 302 generates an electrical measuring signal according to a received light, or respectively a received light intensity. Per sensor element 300, the measuring signal is to be taken into account both by row as well as by column (i.e., contribute to the distance histograms formed by row and column). For this purpose, each SiPM 302 is connected to a row line 304-308 and to a column line 310-314.

The signals applied simultaneously to the row lines 304-308 and to the column lines 310-314 may be used to form the distance histograms by row and column.

The connection to the row lines 304-308 and to the column lines 310-314 is established by a current mirror 316, the adjacently shown example is formed by a conventional circuit of two semiconductor transistors 318. The row lines 310-314 are supplied by one of the semiconductor transistors 318, and the row lines 304-308 are supplied by the other one.

This design represents a simple and reliable version for enabling the desired simultaneous determination of received light for sensor elements 300 in the strip-shaped areas, or more precisely, in the individual rows Z and columns S.

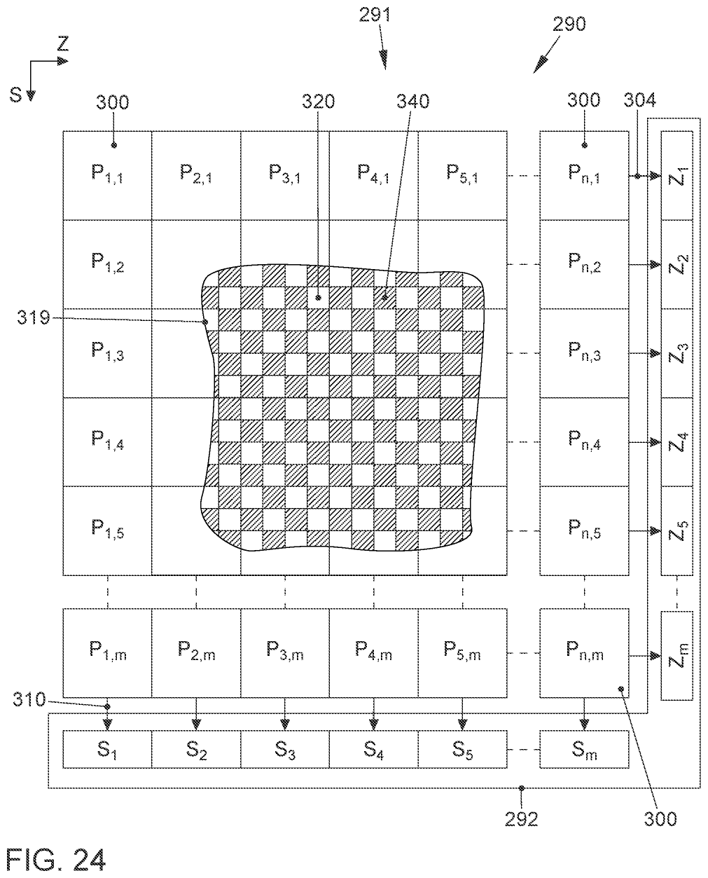

FIG. 24 shows a schematic section of a sensor assembly 290 according to another exemplary embodiment. Sensor elements 300 arranged like a matrix are again shown (not all provided with a corresponding reference sign) whose inner design is however only indicated very roughly and only in a selected and schematically outlined portion 319.

It is shown that each sensor element 300 includes a plurality of photodetector elements 320, 340 that are combined into two groups. Stated more precisely, a first light group of photodetector elements 320 and a second dark group of photodetector elements 340 are shown, wherein each group for example may comprise 16 individual photodetector elements 320, 340. The photodetector elements 320, 340 may be formed in the form of SPADs described above that are combined into one or more SIPMs or are comprised thereof.

It may be seen that the photodetector elements 320, 340 of the individual groups are arranged like a chessboard so that two sequential photodetector elements 320, 340 in the column and row direction of a group each include one photodetector element 320, 340 of the other group. The photodetector elements 320, 340 of the individual groups are therefore arranged alternatingly in the column and row direction.

The photodetector elements 320 of the one group supply a measuring signal that is applied to a row line (see for example the marked row line 304). The photodetector elements 340 of the other group supply a measuring signal that is applied to a column line (see for example the marked row line 310).

This ensures that without additional hardware components in the form of the current mirror or other amplification circuits (that may however optionally also be provided), a measuring signal of a sensor element 300 may be read out both by row as well as by column and for example simultaneously.

FIG. 24 again illustrates that measurements are performed for each row Z (shown for example as Z₁ of Zₘ) and each column S (shown for example as S₁ of Sₘ), and for example the described column-wise and row-wise distance histograms are formed.

Finally, FIG. 24 also indicates that the sensor assembly 290 may be divided into a sensor 291 that includes the sensor elements 300 and accordingly the measuring-signal-supplying units. The column-wise and row-wise distance histograms may in contrast be determined by a processing unit 292, as indicated by way of example, the function of which has already been explained in conjunction with the aforementioned figures and which may be generally designed similar to those figures.

For the sake of completeness, it should be noted that the outermost sensor elements 300 of the rows P_{1,1} to P_{n,1} and P_{1,m} to P_{n,m} as well as the columns P_{n,1} to P_{n,m} and P_{1,1} to P_{1,m} (and optionally also other rows and columns adjacent thereto) are edge areas in which, instead of simultaneous detection or triggering, sequential detection, or respectively triggering of the corresponding sensor elements 300 could also take place. This is based on the idea that relevant objects will probably be detectable less frequently in these areas than, for example, in a central area of the matrix-shaped sensor element arrangement.

### LIST OF REFERENCE NUMERALS

10 Vehicle
11 Light source
12 Optical sensor
13 Processing unit
14 Driver assist system
15 Light
16 Reflected light
17 Object
18 Distance
20 Method
21-25 Step
30 Method
31-35 Step
40 LED light source
41 LED
42 Shift element
43 Energy storage element
44 Modulated signal
45 Ground connection
46 Power supply connection
47 First connection
48 Second connection
50-52 Connections
54 Housing
60 Method
61-67 Step
71, 72 Detection area
81-84 Detection area
121-127 Lighting area
131-136 Detection area
151 Light strip
170 Method
171-174 Step
181 Roadway
182 Vehicle
191 Echogram
201 Echogram
210 Vehicle
211 Infrastructure object
212 Light propagation arrow
213 Transmission data
220 Method
221-226 Step
291 Sensor
292 Processing unit
300 Sensor element
S Columns
Z Rows
302 SiPM
320, 340 Photodetector element
304-308 Row line
310-314 Column line
316 Current mirror
318 Semiconductor transistors
319 Portion

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments.

The mere fact that certain measures are recited in mutually different dependent claims or embodiments does not indicate that a combination of these measures cannot be used to advantage. Any reference signs in the claims should not be construed as limiting the scope.

What is claimed is:

1. A sensor assembly for a vehicle for detecting distance information, comprising:
a sensor that is configured to receive light which is reflected by a scene in the environment; and
a processing circuit that is configured to determine several first distance histograms depending on the received light, wherein a particular first distance histogram of the several first distance histograms is assigned a particular first strip-shaped area of the scene, wherein the first distance histogram includes a strength of reflections in a distance area by objects in the assigned first strip-shaped area; and
that is furthermore configured to determine several second distance histograms depending on the received light, wherein a particular second distance histogram of the several second distance histograms is assigned a particular second strip-shaped area of the scene, wherein the second distance histogram includes a strength of reflections in a distance area by objects in the assigned second strip-shaped area; and
that is furthermore configured to determine distance information for an area of the scene depending on the several first distance histograms and the several second distance histograms, wherein the area of the scene includes an intersecting area of one of the first strip-shaped areas with one of the second strip-shaped areas; wherein
the strip-shaped areas of the scene each correspond with strip-shaped areas of the sensor; and wherein
the sensor assembly is configured to simultaneously determine the light received therein of a plurality of the corresponding strip-shaped areas.

2. The sensor assembly of claim 1, wherein the sensor is configured to simultaneously determine the light received therein for at least 50% of the corresponding strip-shaped areas.

3. The sensor assembly of claim 1, wherein the corresponding strip-shaped areas of the sensor are divided into areas in which the light received therein is determined simultaneously, and into areas in which the light received therein is not determined simultaneously.

4. The sensor assembly of claim 3, wherein the areas at least partially lie within an edge area of the sensor without simultaneously determining the received light.

5. The sensor assembly of claim 1, wherein the sensor comprises a sensor matrix with sensor elements arranged in rows and columns that are each configured to receive light, wherein the rows with the first strip-shaped areas correspond to the scene, and the columns with the second strip-shaped areas correspond to the scene.

6. The sensor assembly of claim 5, wherein the sensor elements in the rows and columns are each interconnected, and the distance histograms are determined from an overall signal of correspondingly interconnected sensor elements.

7. The sensor assembly of claim 5, wherein at least those sensor elements whose received light is determined simultaneously each a current mirror arrangement that is connected to a row line and to a column line to which other current mirror arrangements of other sensor elements are also connected.

8. The sensor assembly of claim 5, wherein at least those sensor elements whose received light is simultaneously determined at least two photodetector elements that each receive light, and wherein one of the photodetector elements is connected to a row line, and the other to a column line.

9. The sensor assembly of claim 8, wherein more than two photodetector elements are provided and these are combined into two groups, wherein the photodetector elements of the one group are connected to a row line, and the photodetector elements of the one group are connected to a column line, and wherein at least two photodetector elements of the one group comprise at least one photodetector element of the other group between themselves.

10. A method for detecting distance information for a vehicle, comprising:
receiving light with a sensor that is reflected by a scene in the environment;
determining several first distance histograms depending on the received light, wherein a particular first distance histogram of the several first distance histograms is assigned a particular first strip-shaped area of the scene, wherein the first distance histogram includes a strength of reflections in a distance area by objects in the assigned first strip-shaped area;
determining several second distance histograms depending on the received light, wherein a particular second distance histogram of the several second distance histograms is assigned a particular second strip-shaped area of the scene, wherein the second distance histogram includes a strength of reflections in a distance area by objects in the assigned second strip-shaped area; and
determining distance information for an area of the scene depending on the several first distance histograms and the several second distance histograms, wherein the area of the scene includes an intersecting area of one of the first strip-shaped areas with one of the second strip-shaped areas;
wherein
the strip-shaped areas of the scene each correspond with strip-shaped areas of the sensor; and
wherein,
for a plurality of the corresponding strip-shaped areas, the light received therein is determined simultaneously.

11. The sensor assembly of claim 2, wherein the corresponding strip-shaped areas of the sensor are divided into areas in which the light received therein is determined simultaneously, and into areas in which the light received therein is not determined simultaneously.

12. The sensor assembly of claim 11, wherein the areas at least partially lie within an edge area of the sensor without simultaneously determining the received light.

13. The sensor assembly of claim 2, wherein the sensor comprises a sensor matrix with sensor elements arranged in rows and columns that are each configured to receive light, wherein the rows with the first strip-shaped areas correspond to the scene, and the columns with the second strip-shaped areas correspond to the scene.

14. The sensor assembly of claim 3, wherein the sensor comprises a sensor matrix with sensor elements arranged in rows and columns that are each configured to receive light, wherein the rows with the first strip-shaped areas correspond to the scene, and the columns with the second strip-shaped areas correspond to the scene.

15. The sensor assembly of claim 4, wherein the sensor comprises a sensor matrix with sensor elements arranged in rows and columns that are each configured to receive light, wherein the rows with the first strip-shaped areas correspond to the scene, and the columns with the second strip-shaped areas correspond to the scene.

16. The sensor assembly of claim 1, wherein the sensor elements in the rows and columns are each interconnected, and the distance histograms are determined from an overall signal of correspondingly interconnected sensor elements.

17. The sensor assembly of claim 6, wherein at least those sensor elements whose received light is determined simultaneously each include a current mirror arrangement that is connected to a row line and to a column line to which other current mirror arrangements of other sensor elements are also connected.

18. The sensor assembly of claim 6, wherein at least those sensor elements whose received light is simultaneously determined comprise at least two photodetector elements that each receive light, and wherein one of the photodetector elements is connected to a row line, and the other to a column line.

19. The sensor assembly of claim 7, wherein at least those sensor elements whose received light is simultaneously determined comprise at least two photodetector elements that each receive light, and wherein one of the photodetector elements is connected to a row line, and the other to a column line.

20. The sensor assembly of claim 18, wherein more than two photodetector elements are provided and these are combined into two groups, wherein the photodetector elements of the one group are connected to a row line, and the photodetector elements of the one group are connected to a column line, and wherein at least two photodetector elements of the one group comprise at least one photodetector element of the other group between themselves.
